(19) United States
(12) Patent Application Publication
(10) Pub. No.: US 2023/0369951 A1
(43) Pub. Date: Nov. 16, 2023

(54) METHOD FOR MANUFACTURING STATOR AND POWER SUPPLY APPARATUS

(71) Applicant: Toyota Jidosha Kabushiki Kaisha, Toyota-shi (JP)

(72) Inventors: Hiroaki URANO, Miyoshi-shi (JP); Akihide Shimmei, Okazaki-shi (JP); Akihide Takehara, Toyota-shi (JP)

(73) Assignee: Toyota Jidosha Kabushiki Kaisha, Toyota-shi (JP)

(21) Appl. No.: 18/305,439

(22) Filed: Apr. 24, 2023

(30) Foreign Application Priority Data
May 16, 2022 (JP) 2022-080378

(51) Int. Cl. H02K 15/00; H05B 6/10

(52) U.S. Cl. CPC H02K 15/0081; H05B 6/101

(57) ABSTRACT

To reduce the power supply voltage during induction heating using a coil provided in a stator core. A method for manufacturing a stator according to one aspect of the present disclosure includes: disposing a three-phase coil in an annular stator core; and making a three-phase alternating current pass through the three-phase coil, thereby inductively heating the stator core. Capacitors are respectively provided between a power supply configured to supply the three-phase alternating current to ends of the three-phase coil and each one of the ends of coils of respective phases in the three-phase coil, whereby a circuit comprising the three-phase coil serves as a resonant circuit when the three-phase alternating current is made to pass through the three-phase coil.

### CROSS REFERENCE TO RELATED APPLICATIONS

This application is based upon and claims the benefit of priority from Japanese patent application No. 2022-080378, filed on May 16, 2022, the disclosure of which is incorporated herein in its entirety by reference.

### BACKGROUND

The present disclosure relates to a method for manufacturing a stator, and a power supply apparatus.

One of the known structures of stators in rotating electric machines is a structure in which segment coils are arranged in multiple slots provided in the stator core. Japanese Unexamined Patent Application Publication No. 2021-65056 discloses a technique related to a stator manufacturing apparatus that can prevent axial opening among a plurality of laminated steel plates during energization heating. In the technique disclosed in Japanese Unexamined Patent Application Publication No. 2021-65056, a stator core is heated by placing a coil for induction heating in the vicinity of the stator core.

### SUMMARY

In the above-mentioned technique disclosed in the Japanese Unexamined Patent Application Publication No. 2021-65056, there is a problem that the manufacturing cost increases because a separate coil for induction heating needs to be provided. In order to solve such a problem, for example, induction heating of the stator core by making three-phase alternating current of a predetermined frequency pass through the coil provided in the stator core can be considered.

However, since the coils provided in the stator core have a large number of turns, there is a problem that a high-voltage power supply equipment is required to inductively heat the stator core by making three-phase alternating current pass through the coil.

In view of the above problems, an object of the present disclosure is to provide a method for manufacturing a stator, and a power supply apparatus that can reduce the power supply voltage during induction heating using a coil provided in a stator core.

A method for manufacturing a stator according to one aspect of the present disclosure includes: disposing a three-phase coil in an annular stator core; and making a three-phase alternating current pass through the three-phase coil, thereby inductively heating the stator core. Capacitors are respectively provided between a power supply configured to supply the three-phase alternating current to ends of the three-phase coil and each one of the ends of coils of respective phases in the three-phase coil, whereby a circuit comprising the three-phase coil serves as a resonant circuit when the three-phase alternating current is made to pass through the three-phase coil.

In the above described method for manufacturing a stator, the three-phase coil may comprise a U-phase coil, a V-phase coil, and a W-phase coil, the capacitors may be respectively a U-phase capacitor, a V-phase capacitor, and a W-phase capacitor, and the U-phase capacitor may be connected in series with the U-phase coil, the V-phase capacitor may be connected in series with the V-phase coil, and the W-phase capacitor may be connected in series with the W-phase coil.

In the above described method for manufacturing a stator, a frequency of the three-phase alternating current may be 1 kHz or greater.

In the above described method for manufacturing a stator, the three-phase coil may comprise segment coils, and each of the segment coils may be disposed so that it straddles a plurality of slots of the stator core, to thereby form a distributed winding.

The above described method for manufacturing a stator may further include: disposing, when the three-phase coil is disposed in the stator core, the three-phase coil and a slot paper in the slots of the stator core; and inductively heating the stator core, thereby fixing the three-phase coil to the stator core using the slot paper.

A power supply apparatus according to one aspect of the present disclosure is a power supply apparatus configured to make a three-phase alternating current pass through a three-phase coil disposed in an annular stator core, to thereby inductively heat the stator core. The power supply apparatus includes: a power supply configured to generate the three-phase alternating current; and capacitors respectively connected between each one of the ends of coils of respective phases in the three-phase coil and the power supply. Each of the capacitors has such a capacity that a circuit comprising the three-phase coil and the each of the capacitors serves as a resonant circuit when the three-phase alternating current is made to pass through the three-phase coil.

In the present disclosure, capacitors are respectively provided between the power supply that supplies a three-phase alternating current and each one of the ends of the three-phase coil. The capacity of each of the capacitors is such that the circuit including the three-phase coil and each capacitor serves as a resonant circuit when a three-phase alternating current is made to pass through the three-phase coil. Therefore, it is possible to reduce the power supply voltage during induction heating using the three-phase coil provided in the stator core.

With the present disclosure, it is possible to provide a method for manufacturing a stator, and a power supply apparatus that can reduce the power supply voltage during induction heating using a coil provided in a stator core.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a perspective view showing an example of a stator manufactured using a method for manufacturing a stator according to an embodiment;

FIG. 2 is a cross-sectional view for explaining a coil and a slot paper placed in the stator;

FIG. 3 is a circuit diagram of a power supply apparatus and a coil disposed in the stator according to the embodiment;

FIG. 4 is a graph showing a relation between a voltage and an impedance required to make a current of 200 Arms pass through;

FIG. 5 is a graph showing an example of a temperature when the stator is heated using the power supply apparatus according to the embodiment; and

FIG. 6 is a circuit diagram for explaining the power supply apparatus according to the related art.

### DESCRIPTION OF EMBODIMENTS

Embodiments will be described below with reference to the drawings.

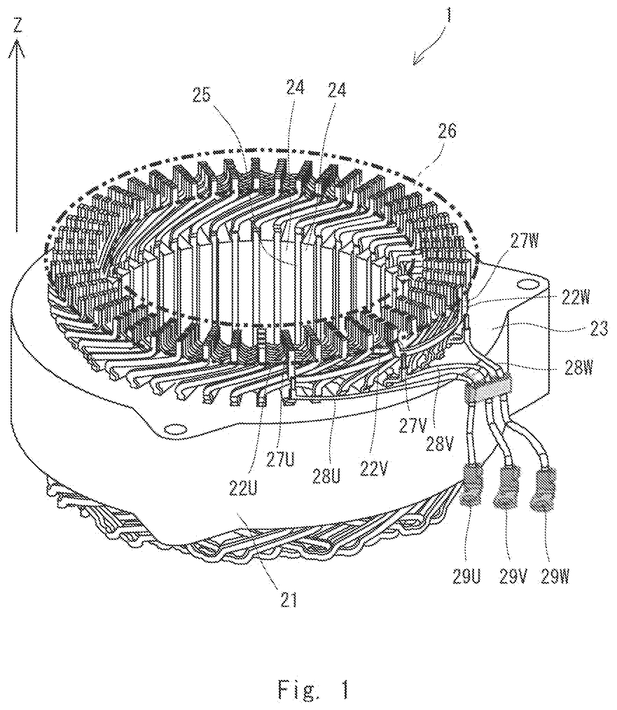

First, a stator manufactured using a method for manufacturing a stator according to the present embodiment will be described. FIG. 1 is a perspective view showing an example of a stator manufactured using the method for manufacturing a stator according to the present embodiment.

As shown in FIG. 1, a stator 1 includes a stator core 21, coils (three-phase coil) 22U, 22V, and 22W wound around the stator core 21, lead wires 28U, 28V, and 28W, and terminals 29U, 29V, and 29W. In this embodiment, the coils 22U, 22V, and 22W are sometimes collectively referred to as a coil 22. Similarly, the lead wires 28U, 28V, and 28W and the terminals 29U, 29V, and 29W may be respectively referred to as a lead wire 28 and a terminal 29.

The stator core 21 includes an annular yoke 23 extending along a stator circumferential direction in which an annular (approximately cylindrical) electrical steel plate is stacked in the axial direction (the Z-axis direction in FIG. 1) of the stator 1, and a plurality of teeth 24 protruding from the inner circumferential surface of the yoke 23 inward in the stator radial direction. The plurality of teeth 24 are arranged so that they are spaced apart from each other in the circumferential direction, and slots 25 are formed between the teeth 24 adjacent to each other in the stator circumferential direction.

The coils 22U, 22V, and 22W comprise a three-phase coil. That is, the coil 22U comprise a U-phase coil, the coil 22V comprise a V-phase coil, and the coil 22W comprise a W-phase coil. The coils 22U, 22V, and 22W may be formed, for example, by connecting a plurality of copper wires to each other by welding or the like. Further, the coils 22U, 22V, and 22W may be so-called segment coils formed in an approximately U shape.

Each of the coils 22U, 22V, and 22W is mounted on each tooth 24 through the slot 25 between the teeth 24. Specifically, each of the coils 22U, 22V, and 22W is provided in the stator core 21 (the teeth 24) through the slots 25 whose stator circumferential positions are different from each other. In other words, each of the coils 22U, 22V, and 22W is disposed so that it straddles a plurality of slots 25 of the stator core 21, to thereby form a distributed winding.

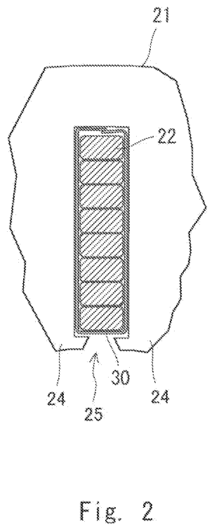

Further, in the present embodiment, as shown in FIG. 2, when the coil 22 is disposed in the slot 25 of the stator core 21, a slot paper 30 is disposed together with the coil 22. By disposing the slot paper 30, the coil 22 can be fixed to the stator core 21. That is, when the stator core 21 is inductively heated, the slot paper 30 disposed between the stator core 21 (the teeth 24) and the coil 22 melts, and then is cooled, whereby the coil 22 is fixed to the stator core 21 (the teeth 24). In the present embodiment, any member other than the slot paper 30 which can fix the coil 22 to the stator core 21 may be used. For example, a foam insulator may be used.

As shown in FIG. 1, a coil end 26 of each coil 22U, 22V, and 22W is bent and joined in the stator circumferential direction. The coils 22U, 22V, and 22W have coil end parts 27U, 27V, and 27W, respectively. The coil end parts 27U, 27V, and 27W are disposed so that they are spaced from each other in the stator circumferential direction at the position of the coil end 26 that projects in the Z-axis direction from the stator core 21, and extend along the Z-axis direction. The lead wires 28U, 28V, and 28W are electrically connected to the coil end parts 27U, 27V, and 27W, respectively.

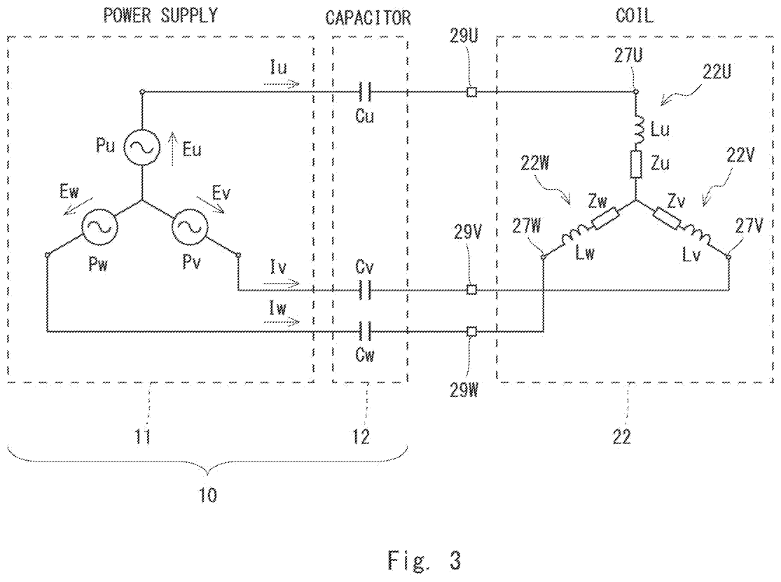

Specifically, one end of the lead wire 28U is welded to the coil end part 27U. Similarly, one end of the lead wire 28V is welded to the coil end part 27V. One end of the lead wire 28W is welded to the coil end part 27W. By the above, the coils 22U, 22V, and 22W (the three-phase coil) are star-connected with each other (see FIG. 3).

The lead wires 28U, 28V, and 28W are formed, for example, by rectangular conductor wires in which metal conductors such as copper wires are coated with insulating members made of enamel resin or the like. Regarding the lead wires 28U, 28V, and 28W, the above insulating members are removed at the coil end parts 27U, 27V, and 27W so that the metal conductors are exposed. Further, the terminals 29U, 29V, and 29W are provided at the other ends of the lead wires 28U, 28V, and 28W, respectively.

Next, the power supply apparatus used in the method for manufacturing a stator according to the present embodiment will be described. FIG. 3 is a circuit diagram of a power supply apparatus and a coil disposed in the stator according to the present embodiment. A power supply apparatus 10 according to the present embodiment is a power supply apparatus for inductively heating the stator core 21 by making three-phase alternating current of a predetermined frequency pass through the coils 22U, 22V, and 22W disposed in the annular stator core 21.

The power supply apparatus 10 according to the present embodiment includes a power supply 11 that generates a three-phase alternating current and capacitors 12. The power supply 11 includes an AC power supply Pu that generates a U-phase AC voltage Eu, an AC power supply Pv that generates a V-phase AC voltage Ev, and an AC power supply Pw that generates a W-phase AC voltage Ew. The AC voltages respectively generated by the AC power supplies Pu, Pv, and Pw are three-phase alternating currents the phases of which are shifted from each other by 120 degrees.

For example, the phase of the U-phase AC voltage Eu generated by the AC power supply Pu is advanced by 120 degrees from the phase of the V-phase AC voltage Ev generated by the AC power supply Pv. Further, the phase of the V-phase AC voltage Ev generated by the AC power supply Pv is advanced by 120 degrees from the phase of the W phase AC voltage Ew generated by the AC power supply Pw.

The capacitors 12 includes capacitors Cu, Cv, and Cw. The capacitors Cu, Cv, and Cw are respectively connected between the terminals 29U, 29V, and 29W respectively provided at the ends of the coils 22U, 22V, and 22W of respective phases and the power supply 11. Specifically, the capacitor Cu is a U-phase capacitor, which is provided between the AC power supply Pu and the terminal 29U. The capacitor Cv is a V-phase capacitor, which is provided between the AC power supply Pv and the terminal 29V. The capacitor Cw is a W-phase capacitor, which is provided between the AC power supply Pw and the terminal 29W. In other words, the capacitor Cu is connected in series with a coil Lu, the capacitor Cv is connected in series with a coil Lv, and the capacitor Cw is connected in series with a coil Lw.

Note that, each of the capacitors Cu, Cv, and Cw has such a capacity that when a three-phase alternating current of a predetermined frequency is made to pass through the coils 22U, 22V, and 22W, the circuit including the coils 22U, 22V, and 22W and the respective capacitors Cu, Cv, and Cw serves as a resonant circuit. The frequency of the three-phase alternating current is not limited to a particular frequency as long as it is a frequency that can inductively heat the stator core 21. As an example, the frequency of the three-phase alternating current is preferably 1 kHz or greater. Note that a method for determining a capacity of each of the capacitors Cu, Cv, and Cw will be described later.

Next, the method for manufacturing a stator according to the present embodiment will be described. The method for manufacturing a stator according to the present embodiment includes disposing the coil 22 in the annular stator core 21 and inductively heating the stator core 21 by making a three-phase alternating current of a predetermined frequency pass through the coil 22.

Specifically, first, the slot paper 30 and the coil 22 are disposed in the slot 25 of the stator core 21. In the present embodiment, any member other than the slot paper 30 (e.g., a foam insulator) which can fix the coil 22 to the stator core 21 may be used. Then, the coil end 26 side of each of the coils 22 disposed in the slot 25 is formed so as to be tilted in the circumferential direction. Then, the coil end 26 of each of the coils 22 is joined by welding, whereby the three-phase coil 22U, 22V, and 22W (a three-phase AC circuit) is formed.

Further, the lead wires 28U, 28V, and 28W are respectively welded to the coil end parts 27U, 27V, and 27W of the respective coils 22U, 22V, and 22W. Then, the terminals 29U, 29V, and 29W are respectively provided at the ends of the lead wires 28U, 28V, and 28W.

Next, the stator core 21 is inductively heated by making a three-phase alternating current of a predetermined frequency pass through each of the coils 22U, 22V, and 22W. At this time, as electric current passes through each of the coils 22U, 22V, and 22W, energization heating (resistance heating) is performed at the same time. That is, each of the coils 22U, 22V, and 22W is heated by both induction heating and energization heating. This heating of the stator core 21 melts the slot paper 30 (see FIG. 2) disposed between the stator core 21 (the teeth 24) and the coil 22, and subsequent cooling fixes the coils 22U, 22V, and 22W to the stator core 21.

In the present embodiment, as shown in FIG. 3, the capacitors Cu, Cv, and Cw are respectively provided between the power supply 11 and each of the ends (the terminals 29U, 29V, and 29W) of the coils 22U, 22V, and 22W. Each of the capacitor Cu, Cv and Cw has such a capacity that a circuit including the coils 22U, 22V, and 22W serves as a resonant circuit when a three-phase alternating current of a predetermined frequency is made to pass through the coils 22U, 22V, and 22W. The capacity of each of the capacitors Cu, Cv, and Cw will be described in detail below.

As shown in the circuit diagram of FIG. 3, the coil 22U can be represented using an inductor component Lu and a resistance component Zu. Similarly, the coil 22V can be represented using an inductor component Lv and a resistance component Zv. Further, the coil 22W can be represented using an inductor component Lw and a resistance component Zw.

In general, when an AC voltage of a frequency f is applied to a circuit including a coil, a relation between a current I and a voltage V passing through the circuit including the coil is expressed by the following Expression (1). In Expression (1), L is the inductor component (inductance) of the circuit including the coil, R is the resistance component of the circuit including the coil, and C is a capacity component (capacitance) of the circuit including the coil. Further, ω is an angular frequency, and a relation of ω=2πf is satisfied.

$$[ Expression 1 ]$$

$$V = I \times \sqrt{{R}^{2} + {( ω L - \frac{1}{wC} )}^{2}} \qquad ( 1 )$$

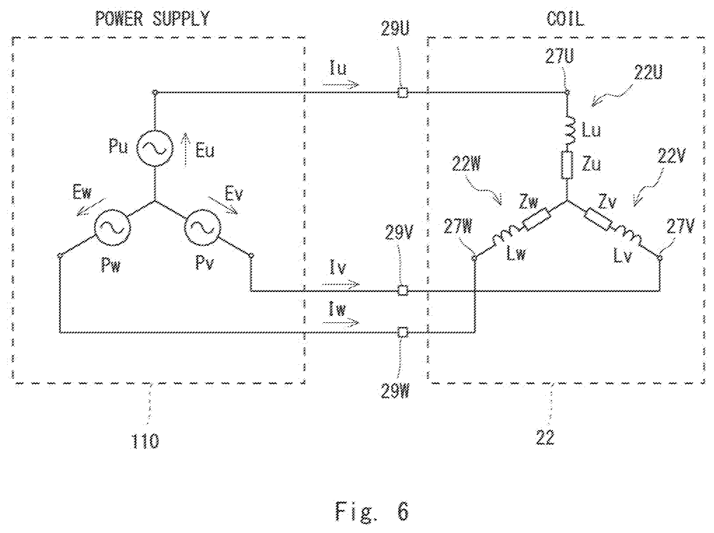

For example, as shown in the circuit diagram in FIG. 6, when the capacitors Cu, Cv, and Cw (see FIG. 3) are not provided, capacitance C is reduced since the capacity component C in Expression (1) is only a parasitic capacitance. In this case, since the value of (ωL−1/ωC)² in Expression (1) increases, the impedance component in Expression (1) increases. Thus, as the impedance component in Expression (1) increases, voltage values V (voltages Eu, Ev, and Ew) required to make currents Iu, Iv, and Iw pass through the coils 22U, 22V, and 22W increase.

In the circuit including the coil 22U and the coil 22V, the inductor components Lu and Lv and the resistance components Zu and Zv are connected in series. For example, when the frequency of the power supply is 1 kHz, the inductance (the sum of Lu and Lv) of the inductor component between two phases (U and V phases) is Ls=536 μH, and the resistance component (the sum of Zu and Zv) is Rs=226.3, a voltage of V=675V is required to make an effective current of 200 Arms pass through the circuit including the coil 22U and the coil 22V as shown in the following equation.

V=200×(Rs²+(2πfLs)²)^{1/2}=675V

In contrast to the above, when the capacitors Cu, Cv, and Cw are provided between the power supply 11 and the coil 22 as shown in FIG. 3, the capacity component C of equation (1) can be increased. In this case, since the value of (ωL−1/ωC)² in Expression (1) can be reduced, the impedance component in Expression (1) can be reduced. Thus, as the impedance component in Expression (1) is reduced, the voltage values V (the voltages Eu, Ev, and Ew) required to make the currents Iu, Iv, and Iw pass through the coils 22U, 22V, and 22W can be reduced.

In the circuit including the coil 22U and the coil 22V, the inductor components Lu and Lv, the resistance components Zu and Zv, and the capacity components Cu and Cv are connected in series. In this case, when the capacity components Cu and Cv are configured so that (ωL−1/ωC)² in Expression (1) becomes 0 (approaches 0), the circuit including the coil 22U and the coil 22V serves as a resonant circuit.

For example, when the frequency of the power supply is 1 kHz, the inductance (the sum of Lu and Lv) of the inductor component between the two phases (U and V phases) is Ls=536 μH, and the impedance (the sum of Zu and Zv) of the resistance components is Rs=226.3, a capacity value where (ωL−1/ωC)²=0 is C=47.4 μF. Therefore, by providing the capacities Cu and Cv in which the total capacity of the capacity components Cu and Cv is C=47.4 μF, the circuit including the coil 22U and the coil 22V can serve as resonant circuit. In this case, a voltage of V=45.2V is required to make an effective current of 200 Arms pass through the circuit including the coil 22U and the coil 22V as shown in the following equation.

V=I×R=200 Arms×0.2263Ω=45.2V

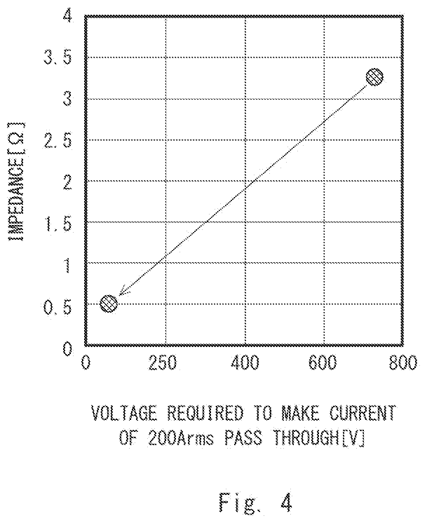

As described above, in the present embodiment, the impedance of the circuit can be reduced by providing the capacitors Cu and Cv in the circuit including the coil 22U and the coil 22V. Thus, as shown in a graph in FIG. 4, a voltage required to make an effective current 200 Arms pass through the circuit including the coils 22U and 22V can be reduced.

The same applies to the circuit including the coil 22V and the coil 22W and the circuit including the coil 22V and the coil 22W.

As described above, the capacitors Cu, Cv, and Cw are provided between the power supply 11 that supplies a three-phase alternating current and the respective ends (the terminals 29U, 29V, and 29W) of the coils 22U, 22V, and 22W. The capacity of each of the capacitors Cu, Cv, and Cw is such that the circuit including the coils 22U, 22V, and 22W and each of the capacitors Cu, Cv, and Cw serves as a resonant circuit when a three-phase alternating current of a predetermined frequency is made to pass through the coils 22U, 22V, and 22W. Therefore, the power supply voltage during induction heating using the coil provided in the stator core can be reduced. In addition, since the power supply voltage during induction heating of the stator core can be reduced, the cost of power supply equipment used to manufacture a stator core can also be reduced.

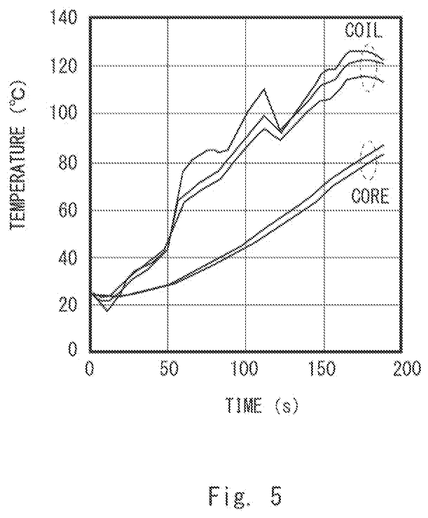

FIG. 5 is a graph showing an example of a temperature when the stator is heated using the power supply apparatus according to the present embodiment. When the stator core 21 was inductively heated by making a three-phase alternating current pass through the coils 22U, 22V, and 22W under the above-described conditions, the temperatures of the core 21 and the coil 22 increased with time. At this time, the stator core 21 was inductively heated by a three-phase alternating current passing through the coil 22. Further, the coil 22 was heated by both induction heating and energization heating by a three-phase alternating current passing through the coil 22. In the example shown in FIG. 5, after about 180 seconds, the temperature of the core 21 reached about 80° C. and the temperature of the coil 22 reached about 125° C. Note that a plurality of lines in the graph in FIG. 5 correspond to a plurality of measurement points in the core 21 and the coil 22.

According to the present disclosure described above, it is possible to provide a method for manufacturing a stator, and a power supply apparatus that can reduce the power supply voltage during induction heating using a coil provided in a stator core.

Note that the present disclosure is not limited to the above-described embodiments and may be changed as appropriate without departing from the scope of the present disclosure. For example, in the above-described stator, a configuration example in which the coils 22 form a distributed winding is shown. However, the present embodiment can be applied to a stator (i.e., a stator of a concentrated winding) having a configuration in which coils are wound around one tooth in a concentrated manner.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A method for manufacturing a stator, the method comprising:
disposing a three-phase coil in an annular stator core; and
making a three-phase alternating current pass through the three-phase coil, thereby inductively heating the stator core,
wherein capacitors are respectively provided between a power supply configured to supply the three-phase alternating current to ends of the three-phase coil and each one of the ends of coils of respective phases in the three-phase coil, whereby a circuit comprising the three-phase coil serves as a resonant circuit when the three-phase alternating current is made to pass through the three-phase coil.

2. The method according to claim 1, wherein
the three-phase coil comprises a U-phase coil, a V-phase coil, and a W-phase coil,
the capacitors are respectively a U-phase capacitor, a V-phase capacitor, and a W-phase capacitor, and
the U-phase capacitor is connected in series with the U-phase coil, the V-phase capacitor is connected in series with the V-phase coil, and the W-phase capacitor is connected in series with the W-phase coil.

3. The method according to claim 1, wherein a frequency of the three-phase alternating current is 1 kHz or greater.

4. The method according to claim 1, wherein the three-phase coil comprises segment coils, and each of the segment coils is disposed so that it straddles a plurality of slots of the stator core, to thereby form a distributed winding.

5. The method according to claim 4, further comprising:
disposing, when the three-phase coil is disposed in the stator core, the three-phase coil and a slot paper in the slots of the stator core; and
inductively heating the stator core, thereby fixing the three-phase coil to the stator core using the slot paper.

6. A power supply apparatus configured to make a three-phase alternating current pass through a three-phase coil disposed in an annular stator core, to thereby inductively heat the stator core,
the power supply apparatus comprising:
a power supply configured to generate the three-phase alternating current; and
capacitors respectively connected between each one of the ends of coils of respective phases in the three-phase coil and the power supply,
wherein each of the capacitors has such a capacity that a circuit comprising the three-phase coil and the each of the capacitors serves as a resonant circuit when the three-phase alternating current is made to pass through the three-phase coil.
